(19) United States
(12) Patent Application Publication
(10) Pub. No.: US 2025/0141334 A1
(43) Pub. Date: May 1, 2025

(54) POWER CONDITIONER WITH NEUTRAL LINE OFFSET CURRENT COMPENSATION FUNCTION AND CONTROL METHOD THEREOF

(71) Applicant: National Taiwan University, Taipei City (TW)

(72) Inventors: Yaow-Ming Chen, Taipei City (TW); Irham Fadlika ., Taipei City (TW); Wen-Yen Li, Taipei City (TW)

(21) Appl. No.: 18/532,703

(22) Filed: Dec. 7, 2023

(30) Foreign Application Priority Data
Oct. 25, 2023 (TW) 112140909

(51) Int. Cl. H02M 1/00; H02M 1/088; H02M 7/5387

(52) U.S. Cl. CPC H02M 1/0012; H02M 1/0009; H02M 1/088; H02M 7/53873

(57) ABSTRACT

A power conditioner with neutral line offset current compensation function, includes a power converter, a measurement unit, a control module, and two coupling capacitors connected through the neutral line to a three-phase AC grid. The power conditioner eliminates the offset current on the neutral line by compensating the inaccuracies in the measurement unit with the control module, thus minimizing the voltage deviation of the coupling capacitors. Compared to traditional control circuits, a feedback path is added to achieve the elimination of the neutral line offset current, suppressing unstable and unpredictable voltage fluctuations on the coupling capacitors without affecting the rated power transmission of the power converter, thus extending the lifespan of the coupling capacitors and enabling the power conditioner to operate more stably.

### CROSS-REFERENCE TO RELATED APPLICATIONS

This application claims the priority benefit of TW application serial No. 112140909, filed on Oct. 25, 2023. The entirety of the above-mentioned patent application is hereby incorporated by reference herein and made a part of the specification.

### BACKGROUND OF THE INVENTION

### 1. Field of the Invention

The present invention relates to a power conditioner and control method thereof, particularly a power conditioner with neutral line offset current compensation function and control method thereof

### 2. Description of the Related Art

With reference to FIG. 7, a power conditioner is a circuit used to convert direct current (DC) power into alternating current (AC) power. For example, the power converter is often used as in the process of integrating a DC power source into the utility grid. Taking the common three-phase AC grid as an example, the power conditioner comprises a power converter 5, an upper capacitor C1, a lower capacitor C2, and a measurement circuit and control module (not shown in the figure). The upper capacitor C1 and lower capacitor C2 are coupling separated capacitors, and their connection points are linked to the neutral point n of the three-phase AC grid via a neutral line. The measurement module is connected to the three-phase output end, measuring the three-phase output currents iₐ, i_{b}, i_{c}, and output voltages vₐ, v_{b}, v_{c}, which are then fed back to the control module to enable the control module to independently control the real power and reactive power of each phase through the power converter 5.

However, errors in current measurement may exist due to factors like circuit aging in the measurement module or component mismatch. That is, the feedback current value received by the control module may slightly deviate from the actual current value. This error will persist when calculating the difference between the reference current value and feedback current value and will be further converted into a control signal output through the error amplifier. When the control module operates based on the Pulse Width Modulation (PWM) signal, a neutral line offset current will be generated.

As the measurement and control of each phase current are independently carried out, offset currents i_{ext,a}, i_{ext,b}, i_{ext,c} will appear on the harmonic currents iₐ, i_{b}, i_{c} of each phase in the three-phase AC. Since the offset currents i_{ext,a}, i_{ext,b}, i_{ext,c} are relatively small compared to the expected harmonic currents iₐ, i_{b}, i_{c}, and the polarity of the offset currents i_{ext,a}, i_{ext,b}, i_{ext,c} is uncertain, it is challenging to separate and control them when superimposed. Eventually, the offset currents will converge and flow through the neutral line towards the coupling separated capacitors, creating a total current on the neutral line of iₐ+i_{b}+i_{c}+i_{ext,a}+i_{ext,b}+i_{ext,c}. This results in a voltage deviation Δv in the upper capacitor C1 and lower capacitor C2. Given that the upper capacitor C1 and lower capacitor C2 are connected in series to the DC input power source with a total voltage of Vdc, the voltage on the upper capacitor C1 is Vdc/2+Δv, and the voltage on the lower capacitor C2 is Vdc/2−Δv. When the offset current on the neutral line is positive, since the DC voltage value remains constant, the voltage of the upper capacitor C1 will discharge over time, causing its voltage to drop, while the voltage of the lower capacitor C2 will rise. Conversely, when the offset current on the neutral line is negative, the voltage of the upper capacitor C1 will increase, and the voltage of the lower capacitor C2 will decrease. The deviation of the capacitor voltage from the midpoint of the DC voltage Vdc will impact the operation of the power conditioner, potentially harming the AC grid.

Test results of a simulated power conditioner under simulated AC current measurement errors are provided herein. Table 1 lists the parameters of the power conditioner used for simulation and the three-phase four-wire AC grid. The simulation tests include three different sets of three-phase target real and reactive power values and measurement error amounts.

TABLE 1

| | | |
|---|---|---|
| Power converter rated power: | 3.5 | kVA |
| Rated three-phase voltage RMS (vₐ, | 220 | V |
| v_{b}, v_{c}): | | |
| DC-end voltage | 720 | V |
| Inductance (L) value: | 1.5 | mH |
| Capacitor (C1, C2) value | 1 | mF |
| PWM control signal frequency | 30 | kHz |
| (v_{ga1}-v_{ga2}, v_{gb1}-v_{gb2}, v_{gc1}-v_{gc2}) | | |

First test scenario: All three phases having a target real power value of Pref=1 kW and a target reactive power value of Qref=0.5 KVA, and a set current measurement error for each phase of +0.5 A. FIGS. 8A to 8D sequentially show the simulated result waveforms over time for the three-phase AC voltage vₐ, v_{b}, v_{c}, three-phase AC currents iₐ, i_{b}, i_{c}, three-phase current offsets i_{ext,a}, i_{ext,b}, i_{ext,c}, and the voltages of the upper and lower capacitors vc1 and vc2. In the first test scenario, the obtained offset current is positive, causing the voltage of the upper capacitor C1 to decrease over time, while the voltage of the lower capacitor C2 will gradually increase, both deviating from the DC voltage midpoint (i.e., 360 V).

Second test scenario: Three-phase target real and reactive powers both have a target real power value of Pref=1 kW and a target reactive power value of Qref=0.5 KVA, and a set current measurement error for each phase of −0.5 A. FIGS. 9A to 9D sequentially show the simulated result waveforms over time for the same parameters as the first test scenario. In the second test scenario, the obtained offset current is negative, causing the voltage of the upper capacitor C1 to increase over time, while the voltage of the lower capacitor C2 will gradually decrease, both deviating from the DC voltage midpoint.

Third test scenario: Three-phase target real and reactive powers have varied target values for each phase with Prefa=1 kW, Prefb=0.8 kW, Prefc=1.2 kW and Qrefa=0.4 KVA, Qrefb=0.6 KVA, Qrefc=0.3 KVA, and a set current measurement error for each phase of +0.2 A, −0.3 A, and +0.1 A respectively for phases a, b, and c. FIGS. 10A to 10D sequentially show the simulated result waveforms over time for the same parameters. In the third test scenario, due to the variations in target power and measurement errors for each phase, the resulting offset currents differ for each phase. As a result, the voltages of the capacitors C1 and C2 deviate from the DC voltage midpoint in an irregular manner.

In conclusion, when there are errors in the AC current measurement, these errors will cause the voltages of the upper and lower capacitors to deviate from the midpoint of the DC voltage, which could harm the grid. The results emphasize the need for accurate AC current measurements and robust control techniques to prevent such deviations and ensure the safe operation of power conditioners connected to the AC grid.

### SUMMARY OF THE INVENTION

To achieve the foregoing objective, the power conditioner with neutral line offset current compensation function comprises:
a power conversion module, having two DC input terminals connected to the DC source and at least one AC output terminal connected to the AC grid; and including two capacitors connected in series between the two DC output terminals, with one connection point of the two capacitors connected to a neutral point of the AC grid;
at least one measurement unit, connected to the at least one AC output terminal of the power conversion module for voltage and current measurements, and generating a measured voltage value and a measured current value;
at least one control module, connected to the at least one measurement unit and the power conversion module, generating an ideal control command based on a target power information and the measured voltage value, and comprising a compensation computation mechanism; the compensation computation mechanism performing signal compensation on the ideal control command to produce a compensated control command; the control module producing and outputting a pulse width modulation (PWM) signal to the power conversion module based on the compensated control command; the compensation computation mechanism comprising:
subtracting a target current value from the measured current value to obtain a first difference value; subtracting a feedback value from the first difference value and passing the subtracted outcome through a first proportional amplifier to produce a first proportional amplified difference value; passing the first difference value through an integral amplifier to produce a first integral amplified difference; passing the first integral amplified difference through a second proportional amplifier to produce the feedback value; wherein
the first integral amplified difference and the first proportional amplified difference are used to compensate the ideal control command.

Through the control module executing the aforementioned compensation operation mechanism during the generation of the Pulse Width Modulation (PWM) control signal, the component caused by measurement errors in the ideal control command is eliminated, thereby eliminating the offset current at the neutral point of the coupling capacitors. Since the elimination of measurement errors is carried out through the compensation operation mechanism within the control module, errors can be appropriately eliminated and compensated through the feedback path regardless of the polarity of the measurement errors, effectively preventing operational anomalies in the power conditioner due to the voltage at the capacitor's neutral point. Furthermore, this invention does not require extra capacitor voltage control circuitry in the power conditioner, maintaining the voltage at the neutral points of both capacitors at the DC voltage neutral point with minimal cost increase.

### BRIEF DESCRIPTION OF THE DRAWINGS

FIG. 1 is a block diagram of the circuit architecture of the power conditioner with neutral line offset current compensation function (hereinafter referred to as “power conditioner”) of the present invention.

FIG. 2 is a circuit diagram of the power converter within the power conditioner of the present invention.

FIG. 3 is a block diagram of the circuit architecture of the control module within the power conditioner of the present invention.

FIGS. 4A to 4D are waveform diagrams over time for the three-phase AC voltages, three-phase AC currents, three-phase current offsets, and capacitor voltages during the first test scenario of the power conditioner of the present invention.

FIGS. 5A to 5D are waveform diagrams over time for the three-phase AC voltages, three-phase AC currents, three-phase current offsets, and capacitor voltages during the second test scenario of the power conditioner of the present invention.

FIGS. 6A to 6D are waveform diagrams over time for the three-phase AC voltages, three-phase AC currents, three-phase current offsets, and capacitor voltages during the third test scenario of the power conditioner of the present invention.

FIG. 7 is a schematic diagram of the process of capacitor voltage deviation caused by the flow of neutral line offset current into the neutral point in a power converter.

FIGS. 8A to 8D are waveform diagrams over time for the three-phase AC voltages, three-phase AC currents, three-phase current offsets, and capacitor voltages during the first test scenario of a conventional power conditioner.

FIGS. 9A to 9D are waveform diagrams over time for the three-phase AC voltages, three-phase AC currents, three-phase current offsets, and capacitor voltages during the second test scenario of a conventional power conditioner.

FIGS. 10A to 10D are waveform diagrams over time for the three-phase AC voltages, three-phase AC currents, three-phase current offsets, and capacitor voltages during the third test scenario of a conventional power conditioner.

### DETAILED DESCRIPTION OF THE INVENTION

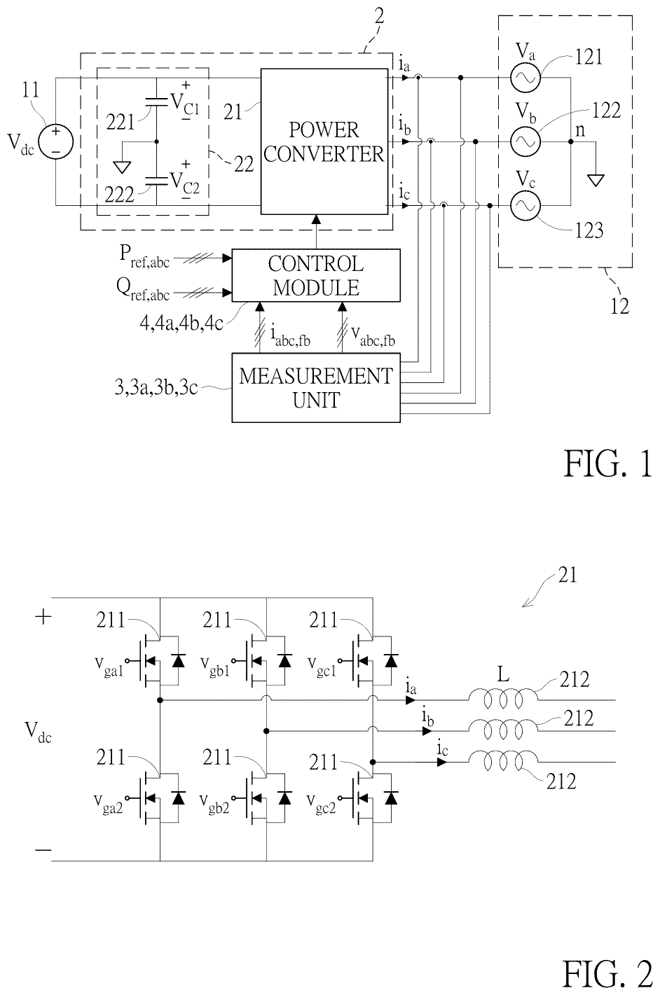

With reference to FIG. 1, a power conditioner having a neutral line offset current compensation function (hereinafter referred to as the “power conditioner”) is connected between a DC power source 11 and an AC power grid 12 to control power transmission between the DC power source 11 and the AC power grid 12. The DC power source 11 provides a DC voltage V_{dc}. In the figures and subsequent descriptions of this invention, the AC power grid 12 will be described with the assumption of being a three-phase-four-wire AC power grid 12, but the invention is not limited to such configuration. The AC power grid 12 has a neutral point n and three phase terminals 121-123, specifically, the first phase terminal 121, the second phase terminal 122, and the third phase terminal 123, providing three-phase AC voltages vₐ, v_{b}, and v_{c}, respectively.

The power conditioner includes a power converting module 2, at least one measurement unit 3, and at least one control module 4. The number of AC output ends of the power converting module 2, the at least one measurement unit 3, and the at least one control module 4 each match the number of phases of the AC power grid 12. In other words, the at least one measurement unit 3 includes measurement units 3a, 3b, and 3c, and the at least one control module 4 includes control modules 4a, 4b, and 4c. It should be noted that, for clarity in FIG. 1, the measurement units 3a, 3b, and 3c are collectively represented as a single block, and the control modules 4a, 4b, and 4c are also collectively represented as a single block. The measurement unit 3a is connected to phase terminal 121 to measure its AC voltages vₐ and the controlled AC currents iₐ output from the power converter 21. The control module 4a is connected to the measurement unit 3a to receive the measured voltage value and measured current value, and controls the AC voltage vₐ and AC current iₐ that the power converting module 2 transmits to the phase terminal 121. The same applies to the measurement units 3b and 3c, control modules 4b and 4c, and phase terminals 122 and 123, which will not be elaborated further here.

The power conversion module 2 has two DC input terminals connected to the DC power source 11, and at least one AC output terminal connected to the phase terminals 121-123 of the AC power grid 12. The power conversion module 2 further includes a power converter 21 and a coupling separated capacitor set 22. The coupling separated capacitor set 22 consists of two capacitors with identical capacitance values, specifically, the upper capacitor 221 and the lower capacitor 222. the upper capacitor 221 and the lower capacitor 222 are connected in series between the two DC input terminals, and a connection point between the upper capacitor 221 and the lower capacitor 222 is connected to the neutral point n of the AC power grid 12 through a neutral line. The power converter 21 is connected between the coupling separated capacitor set 22 and the AC output terminal, receiving PWM signals from the control module 4. Based on the PWM signals, the power converter 21 converts the DC voltage from the DC power source 11 and respectively outputs the controlled AC currents iₐ, i_{b}, and i_{c} to the phase terminals 121-123 of the AC power grid 12.

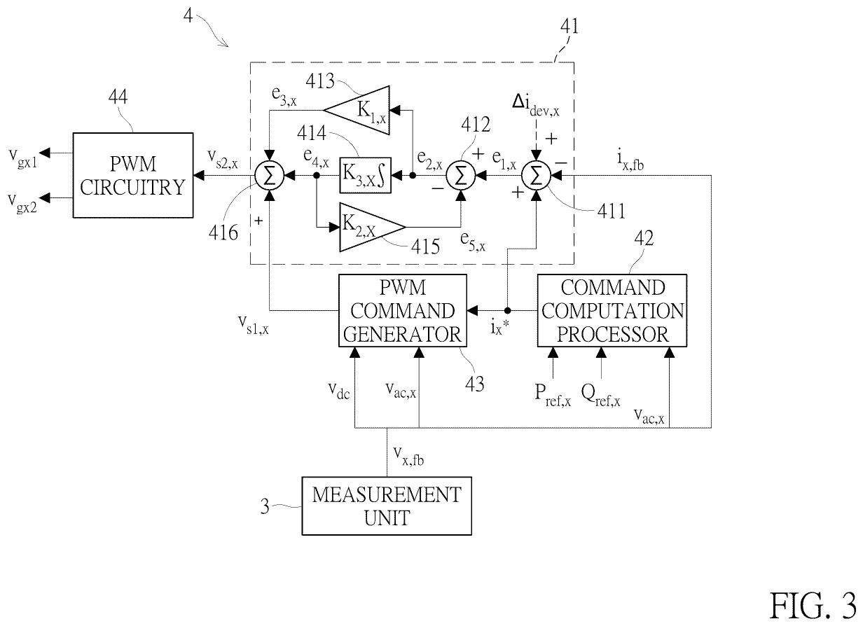

With reference to FIG. 2, the power converter 21 consists of multiple switches 211 and at least one inductor 212. Taking the three-phase AC output as an example, the power converter 21 contains six switches 211 and three inductors 212. The switches 211 are paired and connected in series between the DC power source terminals, representing an upper-arm switch and a lower-arm switch, respectively. Each connection point between the serially-connected switches 211 is connected to one of the phase terminals 121˜123 through the inductor 212. The paired switches 211 each have a control terminal to receive paired PWM control signals v_{ga1}-v_{ga2}, v_{gb1}-v_{gb2}, and v_{gc1}-v_{gc2} from the control module 4.

Further with reference to FIG. 1, each measurement unit 3 is connected to the AC output terminal, measuring the AC voltage and the controlled AC current outputted by the power conversion module 21, generating a measured voltage value and a measured current value. Each control module 4 is connected to the measurement unit 3 to receive the measured voltage value and measured current value, and receives a target power information from an external controller (not shown in the figures herein). The target power information includes a target real power value and a target reactive power value. The control module 4 executes the control method of the power conditioner of the present invention, generating the PWM signal according to the target power information, the measured voltage value and the measured current value. In the aforementioned symbols, the subscript “a,b,c” denotes the endpoints of each phase connected to the three-phase AC power grid.

To be more specific, the control module 4 generates an ideal control signal v_{s1,x} based on the target real power value P_{ref,abc}, target reactive power value Q_{ref,abc}, and the measured voltage value v_{abc,fb}. Furthermore, the control module contains a compensation computation mechanism, which compensates the ideal control signal v_{s1,x} to produce a compensated control signal v_{s2,x}. The control module 4, based on the compensated control signal v_{s2,x}, generates and outputs PWM control signals v_{gx1}-v_{gx2} to the power conversion module 2. The compensation computation mechanism involves the following steps: Subtracting a target current value from the measured current value to obtain a first difference value; subtracting a feedback value from the first difference value and passing the subtracted outcome through a first proportional amplifier to produce a first proportional amplified difference value; passing the first difference value through an integral amplifier to produce a first integral amplified difference; passing the first integral amplified difference through a second proportional amplifier to produce the feedback value. The integral amplified difference value and the first proportional amplified difference value are used to compensate the ideal control signal v_{s1,x}, resulting in the compensated control signal v_{s2,x}. In the subscript symbols, the “x” represents any phase terminal in the three-phase AC power grid.

For clarity, each measurement unit 3 is respectively connected to each phase terminal 121, 122, 123 to measure AC voltages vₐ, v_{b}, v_{c} and the AC currents iₐ, i_{b}, i_{c} outputted by the power conversion module 2. Each control module 4 is connected to its corresponding measurement unit 3 to receive the measured voltage values v_{abc,fb} and the measured current values i_{abc,fb} of that phase. The control module 4 also is connected to the switches 211 of each corresponding phase, outputting paired PWM control signals v_{ga1}-v_{ga2}, v_{gb1}-v_{gb2}, and v_{gc1}-v_{gc2} to control the switches 211 to toggle between conduction state and cutoff state, thereby controlling the output of each phase. The operations between the measurement units 3 and the control modules 4 are independent, ensuring that the AC voltages vₐ, v_{b}, v_{c} and AC currents iₐ, i_{b}, i_{c} delivered to the AC power grid 12 are independently detected and controlled. Under the circuit structure of such, the power converter of the present invention can achieve at least the following objectives:
(a) The real and reactive powers of the three-phase output are stabilized at their target values.
(b) The offset current on the neutral line is eliminated.
(c) The voltages on the capacitors 121, 122 of the coupling separated capacitor set 22 are stabilized near the midpoint of the DC voltage Vdc.

The operating principles of a corresponding set of the measurement unit 3, control module 4, and switches 211 will be described below. The same circuit architecture and control principle can be applied to the measurement units 3a, 3b, 3c and control modules 4a, 4b, 4c of any phase in the power converter, achieving the effect of eliminating the measurement error in the measured current value i_{abc,fb} produced by any measurement unit 3a, 3b, 3c.

With reference to FIG. 3, the measured voltage value v_{x,fb} includes DC voltage component v_{dc} and AC voltage component v_{ac,x}. The measured current value is comprises a real current value as well as a measurement error value Δi_{dev,x}. The control module 4 contains a compensation computing circuitry 41, a command computation processor 42, a PWM command generator 43, and a PWM circuitry 44. The command computation processor 42 is connected to the measurement unit 3 to receive the DC voltage component v_{dc} from the measured voltage value v_{x,fb} and also receives the target real power value P_{ref,abc} and the target reactive power value Q_{ref,abc} from an external controller, thereby producing the target current value iₓ*. The PWM command generator 43 is connected to the command computation processor 42 and the measurement unit 3, receives the target current value iₓ* from the command computation processor 42, and receives both the DC voltage component v_{dc} and the AC voltage component v_{ac,x} from the measurement unit 3. Based on the target current value iₓ*, DC voltage component vdc, and AC voltage component V_{ac,x}, it generates the ideal control signal v_{s1,x}. The compensation computing circuitry 41 is connected to the command computation processor 42, the measurement unit 3, and the PWM command generator 43. It receives the ideal control signal v_{s1,x} from the PWM command generator 43, the target current value iₓ* from the command computation processor 42, and the measured current value i_{x,fb} from the measurement unit 3. The compensation computing circuitry then executes the compensation mechanism to produce the compensated control signal v_{s2,x}.

It should be noted that, the method that the PWM command generator 43 produces the ideal control signal v_{s1,x} based on the target current value iₓ*, the DC voltage component v_{dc}, and the AC voltage component v_{ac,x} may be executed with reference to, for example, formulas 5-7 and 8-9 in the paper titled “Per-Phase Active Power Distribution Strategy for Three-Phase Grid-Tied Inverters Under Unbalanced Conditions Without DC Sources” by T. W. Tsai, Y. C. Li, C. J. Yang, and Y. M. Chen, Vol. 9. No. 6, December 2021, and makes the following assumptions:

θ_{vac,x}=0

P_{comp}=0

The PWM circuitry 44 is connected to the compensation computing circuitry 41 of the control module 4 to receive the compensated control signal v_{s2,x} and generates the PWM control signals v_{ga1}-v_{ga2}, v_{gb1}-v_{gb2}, and v_{gc1}-v_{gc2} to output to the power conversion module 2. To be more specific, the PWM control signals generated by one of the control modules 4 consist of two sub-signals. For instance, the control module 4a produces the PWM control signals v_{ga1} and v_{ga2}, which individually control the two switches 211 connected in series within the power conversion module 2.

With reference to also FIG. 3, the measured current value i_{x,fb} of the three-phase AC current as detected by the measurement unit 3 will contain an additional current measurement error value Δi_{dev,x} due to the imperfections in the circuitry of the measurement unit 3. Each phase current measurement error value Δi_{dev,x} is then transferred to the compensation computing circuitry 41 of the control module 4. The compensation computing circuitry 41 includes a first calculator 411, a second calculator 412, a first proportional amplifier 413, an integral amplifier 414, a second proportional amplifier 415, and a third calculator 416. The first calculator 411 receives the measured current value i_{x,fb} and the target current value iₓ*, subtracting the measured current value i_{x,fb} from the target current value iₓ* to produce the first difference value e_{1,x}. The second calculator 412 is connected to the first calculator 411, receives the first difference value e_{1,x}, subtracts the feedback value e_{5,x}, from the first difference value e_{1,x}, and generates a second output value e_{2,x}. The first proportional amplifier 413 is connected to the second calculator 412 and receives the second output value e_{2,x}. Based on the second output value e_{2,x} and a first gain parameter K_{1,x}, it produces the first proportional amplified difference value e_{3,x}. The integral amplifier 414 is connected to the second calculator 412 and receives the second output value e_{2,x}. It integrates the second output value e_{2,x} over relative time according to the integral gain parameter K_{3,x}∫ to produce an integral amplified difference value e_{4,x}. The second proportional amplifier 415 is connected to the integral amplifier 414 and the second calculator 412, receives the integral amplified difference value e_{4,x}, and based on a second gain parameter K_{2,x} produces a feedback value e_{5,x}, which is then outputted to the second calculator 412. The third calculator 416 is connected to the first proportional amplifier 413 to receive the first proportional amplified difference value e_{3,x}, is connected to the integral amplifier 414 to receive the integral amplified difference value e_{4,x}, and also is connected to the PWM command generator 43 to receive the ideal control signal v_{s1,x}. The third calculator 416 adds the first proportional amplified difference value e_{3,x}, the integral amplified difference value e_{4,x}, and the ideal control signal v_{s1,x} to produce the compensated control signal v_{s2,x}.

In the following, the first gain parameter K_{1,x} for each phase's first proportional amplifier 411 is simplified as the first gain parameter K₁. The second gain parameter K_{2,x} of the second proportional amplifier 415 is simplified as the second gain parameter K₂. The integral gain parameter K_{3,x}∫ of the integral amplifier 414 is simplified as the integral gain parameter K₃. In an embodiment of the present invention, the integral gain parameter K₃ is larger than the second gain parameter K₂, the second gain parameter K₂ is larger than the first gain parameter K₁, and the first gain parameter is larger than 0. In other words:

$${K}_{3} > {K}_{2} > {K}_{1} > 0$$

In one embodiment, the integral gain parameter K₃ is larger than 10 times the first gain parameter K₁.

In another embodiment, the integral gain parameter K₃ is larger than 10 times the second gain parameter K₂.

Test results of a simulated power conditioner of the present invention under simulated AC current measurement errors are provided herein to elaborate the effectiveness of the present invention. Table 2 lists the parameters of the power conditioner used for simulation and the three-phase four-wire AC grid. The simulation tests include three different sets of three-phase target real and reactive power values and measurement error amounts.

TABLE 2

| | | |
|---|---|---|
| Power converter 21 rated power: | 3.5 | kVA |
| Rated three-phase voltage RMS (vₐ, | 220 | V |
| v_{b}, v_{c}): | | |
| DC-end voltage | 720 | V |
| Inductance (L) value: | 1.5 | mH |
| Capacitor (221, 222) value | 1 | mF |
| PWM control signal frequency | 30 | kHz |
| (v_{ga1}-v_{ga2}, v_{gb1}-v_{gb2}, v_{gc1}-v_{gc2}) | | |

| | |
|---|---|
| First gain parameter K1 | 1 |
| Second gain parameter K2 | 2.25 |
| Integral gain parameter K3 | 100 |

First test scenario: All three phases having a target real power value of P_{ref}=1 kW and a target reactive power value of Q_{ref}=0.5 KVA, and the current measurement error for each phase is set at +0.5 A.

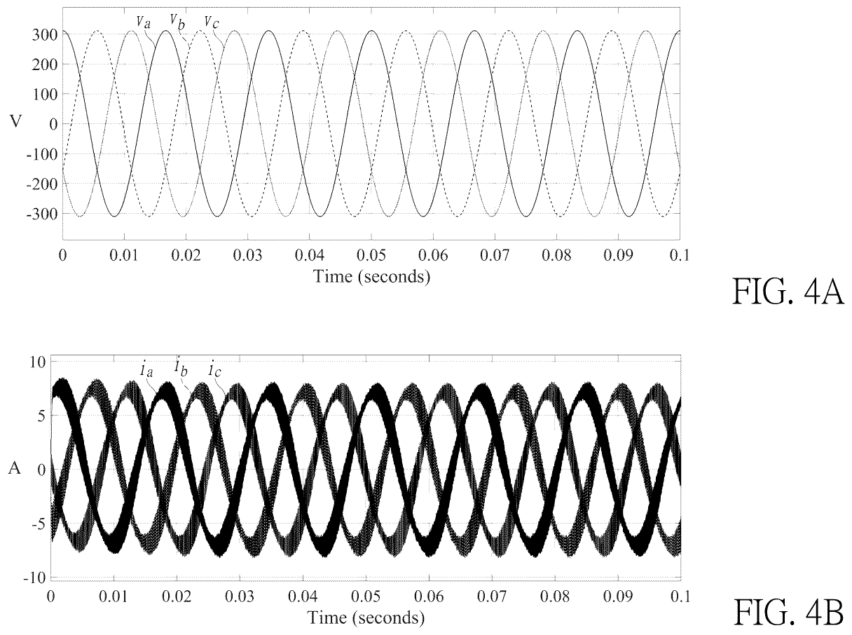

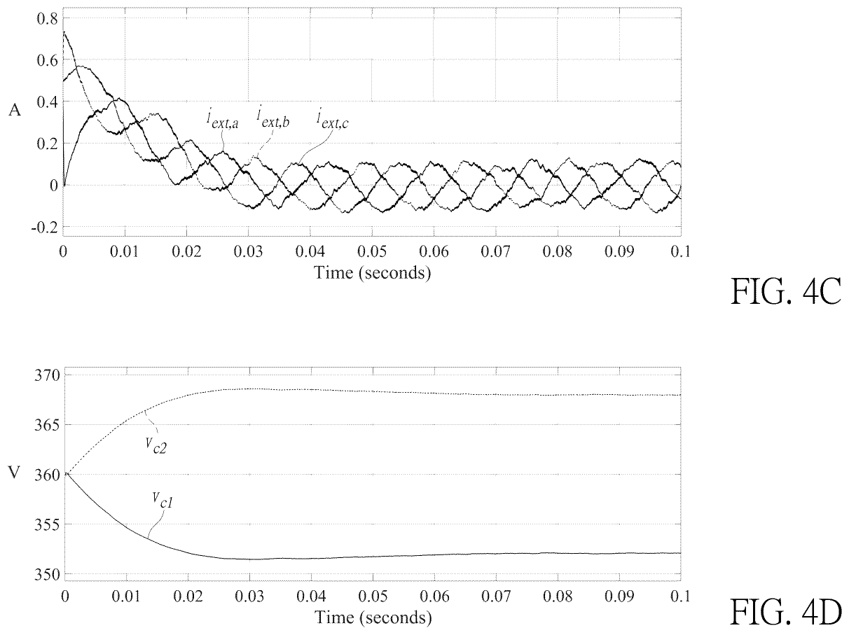

FIGS. 4A to 4D sequentially show the simulated result waveforms over time for the AC voltages vₐ, v_{b}, v_{c}, AC currents iₐ, i_{b}, i_{c}, current offsets i_{ext,a}, i_{ext,b}, i_{ext,c}, and the capacitors voltages V_{C1} and V_{C2} under the first test scenario.

As shown in FIGS. 4A to 4D, under the compensation mechanism of the invention, the offset current flowing through the neutral line is OA, and the voltages of upper capacitor 221 and lower capacitor 222 eventually stabilize at 352V and 368V, respectively. This demonstrates that in the first test scenario, this embodiment can maintain the capacitor voltages V_{C1}, V_{C2} near the midpoint of the DC voltage (V_{dc}/2).

Second test scenario: All three phases having a target real power value of P_{ref}=1 kW and a target reactive power value of Q_{ref}=0.5 KVA, and the current measurement error for each phase is set at −0.5 A.

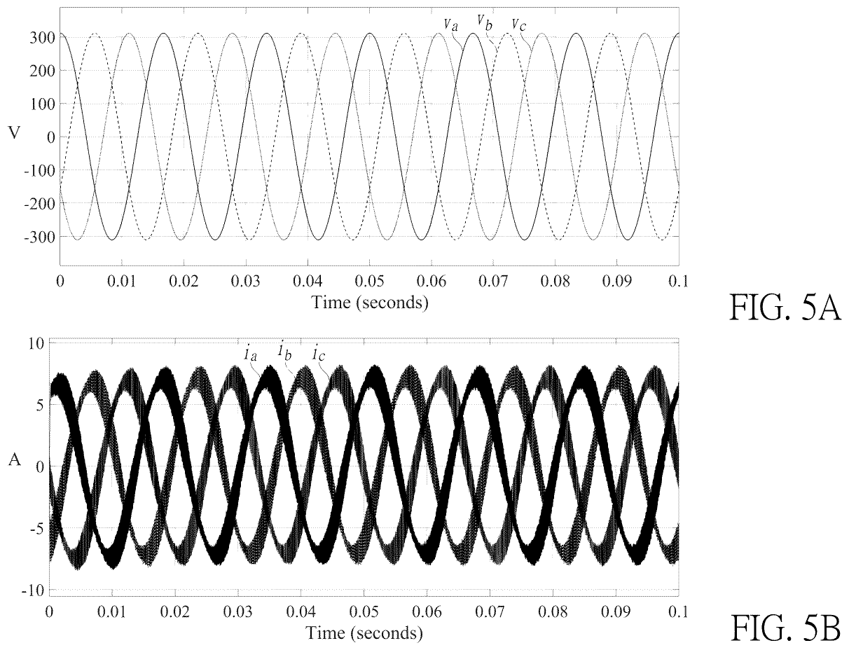

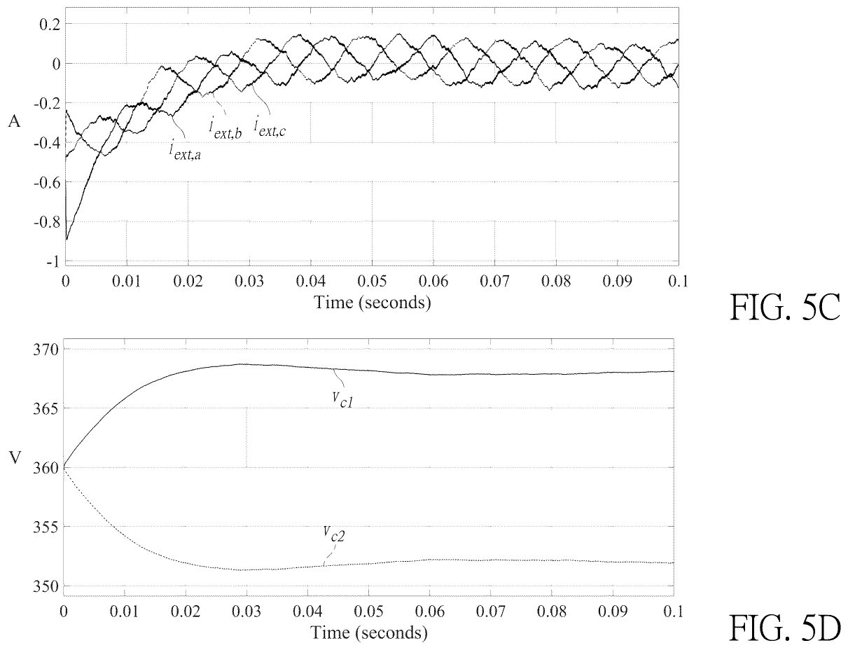

FIGS. 5A to 5D sequentially show the simulated result waveforms over time for the AC voltages vₐ, v_{b}, v_{c}, AC currents iₐ, i_{b}, i_{c}, current offsets i_{ext,a}, i_{ext,b}, i_{ext,c}, and the capacitors voltages v_{C1} and v_{C2} under the second test scenario. As shown in FIGS. 5A to 5D, under the compensation mechanism of the invention, the offset current flowing through the neutral line is 0 A, and the voltages of upper capacitor 221 and lower capacitor 222 eventually stabilize at 368V and 352V, respectively. This demonstrates that in the second test scenario, this embodiment can maintain the capacitor voltages v_{C1} and v_{C2} near the midpoint of the DC voltage (Vdc/2).

Third test scenario: Three phases having different target real and reactive powers, namely, the target power information and the current measurement error are set differently. Phase A: P_{ref,a}=1.25 KW, Q_{ref,a}=0 KVA; phase B: P_{ref,b}=1 KW, Q_{ref,b}=0.5 KVA; phase C: P_{ref,c}=0 KW, Q_{ref,c}=0.75 KVA. Current measurement error of Phase A is 0.5 A, current measurement error of Phase B is −0.75 A, and current measurement error of Phase C is −0.25 A.

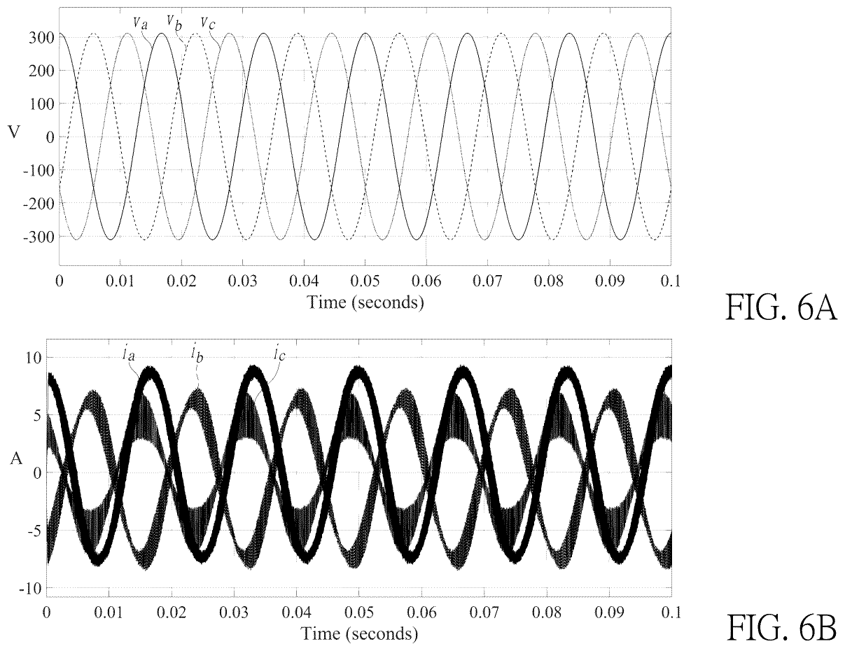

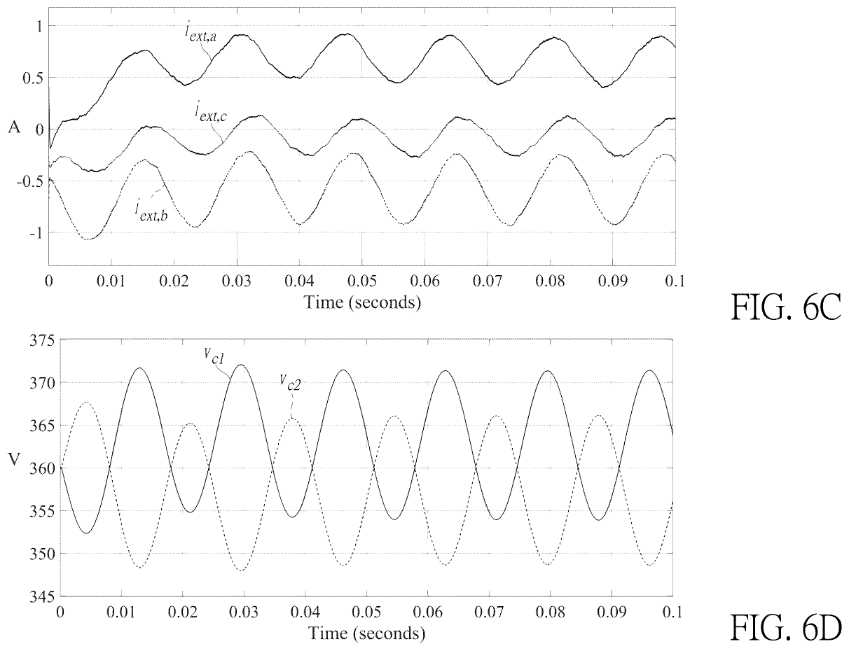

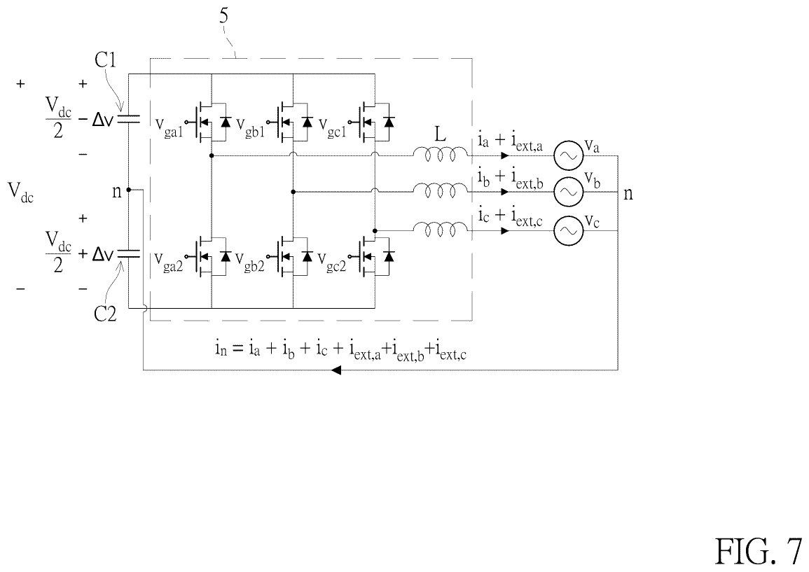

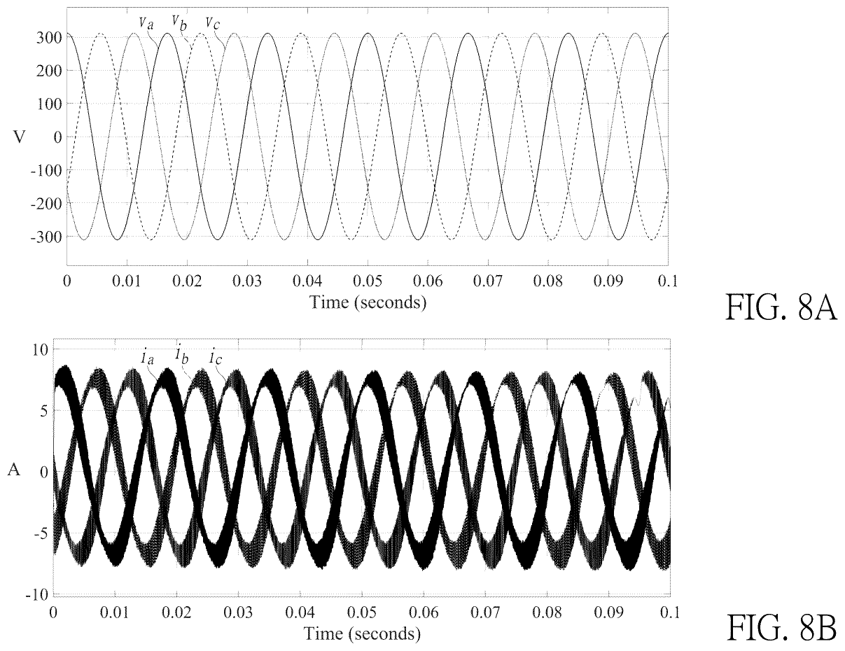

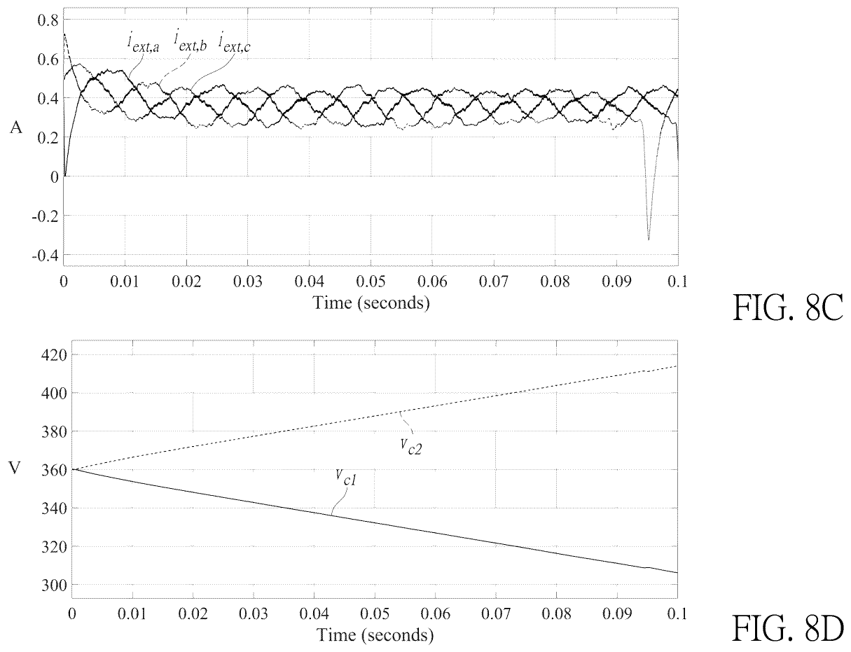

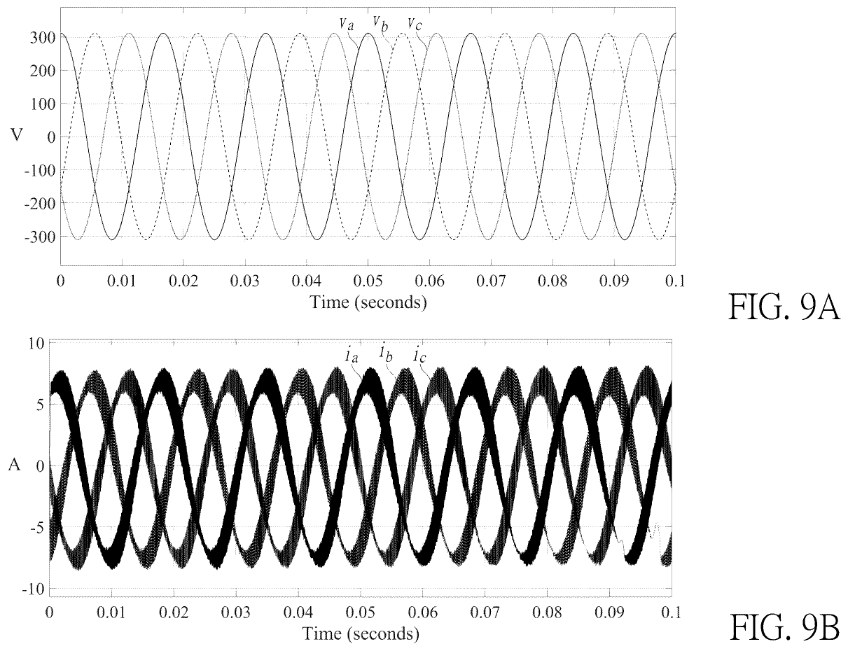

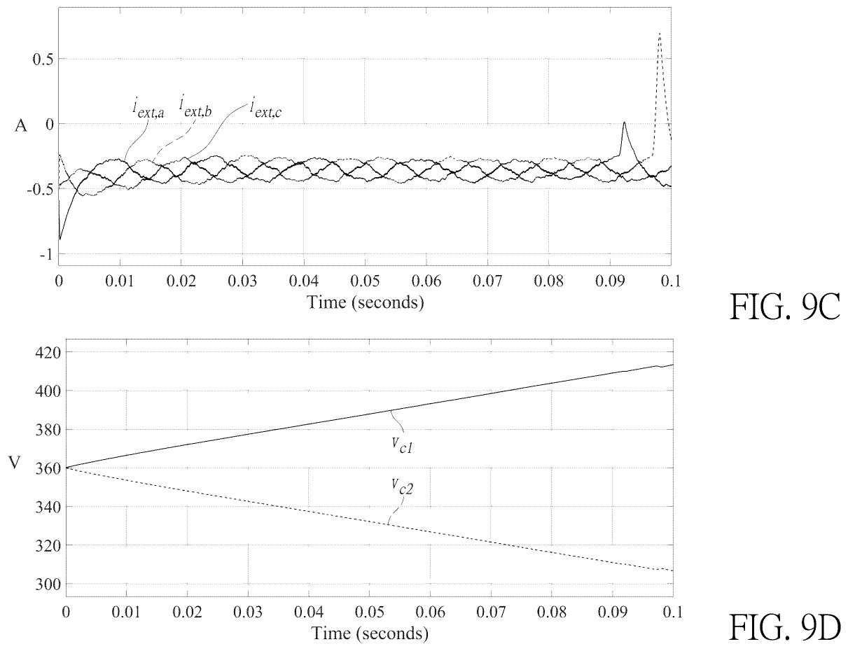

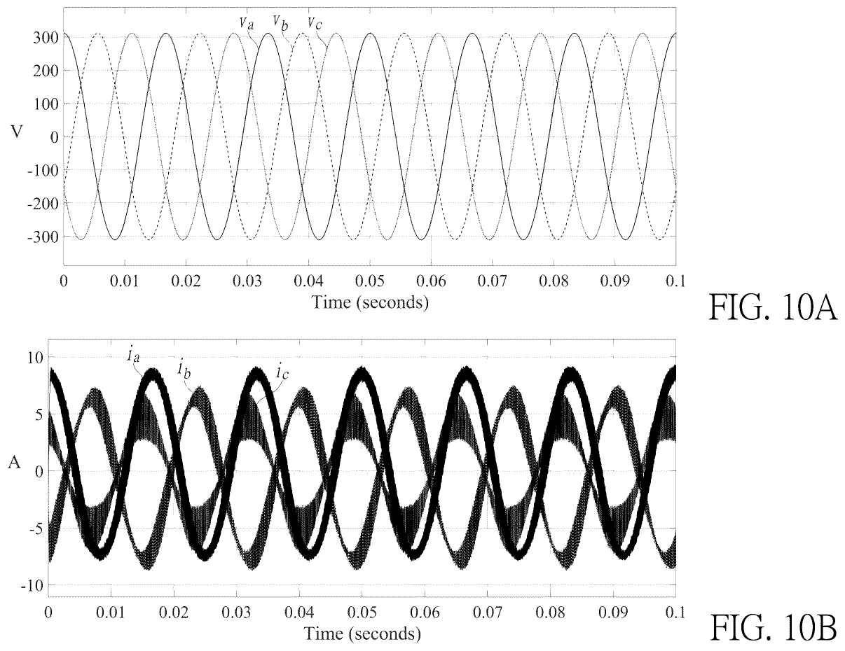

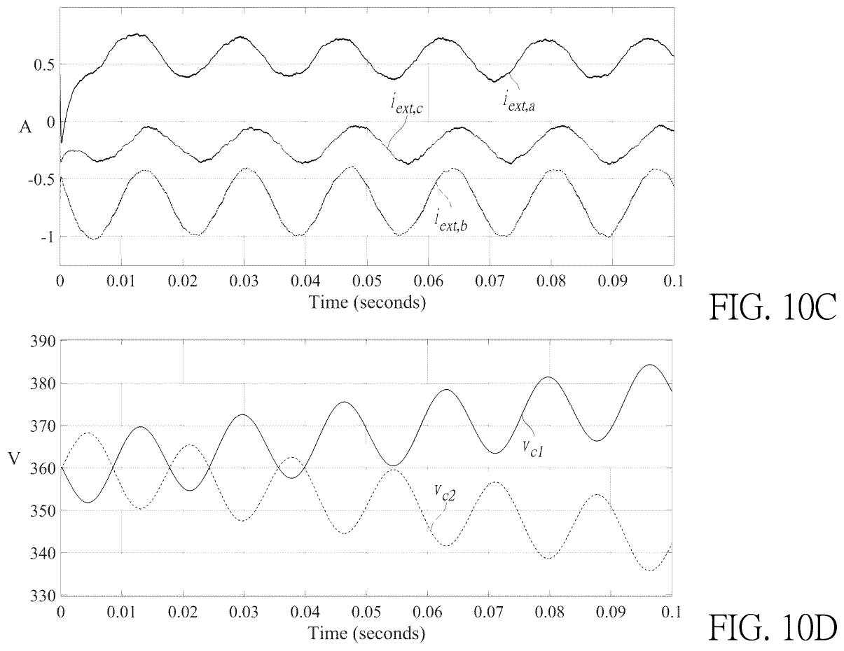

FIGS. 6A to 6D sequentially show the simulated result waveforms over time for the AC voltages vₐ, v_{b}, v_{c}, AC currents iₐ, i_{b}, i_{c}, current offsets i_{ext,a}, i_{ext,b}, i_{ext,c}, and the capacitors voltages v_{c1} and v_{c2} under the second test scenario. As shown in FIGS. 6A to 6D, under the compensation mechanism of the invention, the offset current flowing through the neutral line is OA, and the average voltages of the upper capacitor 221 and lower capacitor 222 eventually stabilize at 368V and 352V with lower AC ripple compared to a power conditioner without compensation mechanism of the invention, respectively. This demonstrates that in the third test scenario, this embodiment can maintain the capacitor voltages v_{C1} and v_{C2} near the midpoint of the DC voltage (Vdc/2).

In summary, the power conditioner of the invention possesses at least the following advantages:

The neutral line offset current caused by current measurement errors is eliminated in the measurement unit 3, and the current measurement errors are compensated regardless of the polarity.

Through the compensation operation circuit 41 in the control module 4, the voltage deviation of the upper capacitor 221 and lower capacitor 222 can be quickly and effectively controlled without the need to add an additional capacitor voltage control loop. This stabilizes the capacitor voltages at the midpoint of the DC voltage, avoiding operational issues in the power conditioner due to capacitor voltage problems.

What is claimed is:

1. A power conditioner with a neutral line bias current compensation function, connected between a direct current (DC) source and an alternating current (AC) grid, the power conditioner comprising:
a power conversion module, having two DC input terminals connected to the DC source and at least one AC output terminal connected to the AC grid; and including two capacitors connected in series between the two DC output terminals, with one connection point of the two capacitors connected to a neutral point of the AC grid;
at least one measurement unit, connected to the at least one AC output terminal of the power conversion module for voltage and current measurements, generating a measured voltage value and a measured current value;
at least one control module, connected to the at least one measurement unit and the power conversion module, generating an ideal control command based on a target power information and the measured voltage value, and comprising a compensation computation mechanism; the compensation computation mechanism performing signal compensation on the ideal control command to produce a compensated control command; the control module producing and outputting a pulse width modulation (PWM) signal to the power conversion module based on the compensated control command; the compensation computation mechanism comprising:
subtracting a target current value from the measured current value to obtain a first difference value; subtracting a feedback value from the first difference value and passing a subtracted outcome through a first proportional amplifier to produce a first proportional amplified difference value; passing the first difference value through an integral amplifier to produce a first integral amplified difference; passing the first integral amplified difference through a second proportional amplifier to produce the feedback value; wherein
the first integral amplified difference and the first proportional amplified difference are used to compensate the ideal control command.

2. The power conditioner as claimed in claim 1 wherein:
the AC grid is a three-phase four-wire AC grid, having three phase terminals;
the amounts of the at least one AC power terminal, the at least one measurement unit, and the at least one control module are each three;
the three AC power terminals are connected to the three phase terminals of the AC grid to output three-phase voltages;
the power conversion module comprises a power converter, the power converter includes three upper-arm switches, three lower-arm switches, and three inductors; the upper-arm switches and the lower-arm switches are pairwise connected in series between the two DC input terminals; a connection point of the upper-arm switches and the lower-arm switches connects to the phase terminals through the inductors;
the control modules are electrically connected respectively with the upper-arm switches and the lower-arm switches, outputting the PWM signals to the upper-arm switches and the lower-arm switches, enabling the DC source to output phase voltages respectively to the three phase terminals through the upper-arm switches and the lower-arm switches.

3. The power conditioner as claimed in claim 1, wherein the at least one control module each comprises:
a command computation processor, connected to the measurement unit to receive the measured voltage value, receiving the target power information from an external controller, and generating the target current value according to the target power information;
a PWM command generator, connected to the command computation processor and the measurement unit, and generating the ideal control command based on the target current value and the measured voltage value;
a compensation computation circuitry, connected to the command computation processor, the measurement unit, and the PWM command generator, receiving the ideal control command, the target current value, and the measured current value, and executing the compensation computation mechanism to produce the compensated control command;
a PWM circuit, connected to the compensation computation circuitry, receiving the compensated control command, and generating the PWM signal base on the compensated control command.

4. The power conditioner as claimed in claim 1, wherein the compensation computation mechanism is executed by a compensation computation circuit, and the compensation computation circuit comprises:
a first calculator, receiving the measured current value and the target current value, subtracting the measured current value from the target current value, and generating the first difference value;
a second calculator, connected to the first calculator to receive the first difference value, subtracting the feedback value from the first difference value, and generating a second output value;
a first proportional amplifier, connected to the second calculator to receive the second output value, and producing a third output value based on the second output value and a first gain parameter;
an integral amplifier, connected to the second calculator to receive the second output value, integrating the second output value over time based on an integration gain parameter, and generating a fourth output value;
a second proportional amplifier, connected to the integral amplifier and the second calculator to receive the fourth output value, producing the feedback value based on the fourth output value and a second gain parameter, and outputting the feedback value to the second calculator; and
a third calculator, connected to the first proportional amplifier to receive the third output value, connected to the integrator amplifier to receive the fourth output value, and connected to the PWM command generator to receive the ideal control command, the third calculator adding up the third output value, the fourth output value, and the ideal control command to produce the compensated control command.

5. The power conditioner as claimed in claim 1, wherein the first proportional amplifier has a first gain parameter, the second proportional amplifier has a second gain amplifier, and the integral amplifier has an integral gain parameter; wherein
the integral gain parameter is larger than the second gain parameter, the second gain parameter is larger than the first gain parameter, and the first gain parameter is larger than 0.

6. The power conditioner as claimed in claim 5, wherein the integral gain parameter is larger than ten times the first gain parameter.

7. The power conditioner as claimed in claim 4, wherein the integral gain parameter is larger than ten times the second gain parameter.

8. A control method of a power conditioner with a neutral line bias current compensation function, the power conditioner connected between a DC source and an AC grid and controlling power transferring between the DC source and the AC grid; the control method comprising:
receiving a measured voltage value and a measured current value, receiving a target power information, and producing an ideal control command according to the measured voltage value and the target power information;
executing a compensation calculation mechanism, performing signal compensation on the ideal control command to produce a compensated control command;
producing a PWM signal and outputting the PWM signal to a power conversion module according to the compensated control command; the compensation calculation mechanism comprising:
subtracting a target current value from the measured current value to obtain a first difference value; subtracting a feedback value from the first difference value and passing a subtracted outcome through a first proportional amplifier to produce a first proportional amplified difference value; passing the first difference through an integral amplifier to produce a first integral amplified difference; passing the first integral amplified difference through a second proportional amplifier to produce the feedback value; wherein
the first integral amplified difference and the first proportional amplified difference are used to compensate the ideal control command.

9. The control method as claimed in claim 8, wherein the first proportional amplifier has a first gain parameter, the second proportional amplifier has a second gain amplifier, and the integral amplifier has an integral gain parameter; wherein
the integral gain parameter is larger than the second gain parameter, the second gain parameter is larger than the first gain parameter, and the first gain parameter is larger than 0.

10. The control method as claimed in claim 9, wherein the integral gain parameter is larger than ten times the first gain parameter; and the integral gain parameter is larger than ten times the second gain parameter.
